(19) United States
(12) Patent Application Publication
(10) Pub. No.: US 2026/0355681 A1
(43) Pub. Date: Nov. 12, 2026

(54) PROCESS FOR RECOVER CARBON DIOXIDE FROM A GAS STREAM

(71) Applicant: Dow Global Technologies LLC, Midland, MI (US)

(72) Inventors: John R. Dowdle, Lake Jackson, TX (US); William L. Jackson, Jr., Baton Rouge, LA (US); Ashwin Kumar Yegya Raman, Lake Jackson, TX (US)

(21) Appl. No.: 19/487,869

(22) PCT Filed: Jun. 21, 2024
(86) PCT No.: PCT/US2024/034890

§ 371 Date: Nov. 25, 2025

Related U.S. Application Data
(60) Provisional application No. 63/512,739, filed on Jul. 10, 2023.

(51) Int. Cl. B01D 53/14

(52) U.S. Cl. CPC B01D 53/1475; B01D 53/1425; B01D 53/1493; B01D 2252/204; B01D 2257/504

(57) ABSTRACT

A process to recover carbon dioxide from a carbon dioxide-rich gaseous feed stream that comprises the following steps: a) an absorption step wherein carbon dioxide is absorbed from the rich feed stream into the aqueous absorbent to produce a gaseous feed stream than contains reduced carbon dioxide, called the “lean feed stream”, and an absorbent containing increased levels of carbon dioxide, called the “rich absorbent”; and b) a regeneration step wherein the rich absorbent from the absorption step is subjected to a regeneration pressure lower than the absorption pressure and a regeneration temperature higher than the absorption temperature for a period of time such that carbon dioxide is desorbed from the absorbent and recovered, to form a lean absorbent that contains less carbon dioxide than the rich absorbent and is returned to the absorption step; and c) a transition step wherein (i) the rich absorbent passing from the absorption step to the regeneration step is heated and depressurized to prepare for the regeneration step and (ii) the lean absorbent passing from the regeneration step to the absorption step is cooled and pressurized to prepare for the absorption step, which transition step includes transferring heat from the lean absorbent to the rich absorbent in one or more heat exchangers, has the following refinements: (1) The regeneration step comprises at least: i. a high pressure regeneration stage, in which carbon dioxide is partially desorbed from the rich absorbent in a separator which is either a flash drum or an in-line separator, to provide a (A) high pressure carbon dioxide stream and (B) a semi-lean absorbent, and ii. a low pressure regeneration stage, in which further carbon dioxide is desorbed from a portion of the semi-lean absorbent in a regeneration column, to provide (A) a low pressure carbon dioxide stream and (B) a lean absorbent stream; and (2) the semi-lean absorbent from the high pressure regeneration stage is split with part of the semi-lean absorbent sent to the low pressure regeneration and part of the semi-lean absorbent returned through the transition step to the absorption step; and The absorption step is carried out in an absorption column, wherein (i) the rich feed stream is introduced into the absorption column in a lower portion of the absorption column and moves toward the top of the column, (ii) the lean absorbent is introduced into the absorption column in an upper portion of the column and moves toward the bottom of the column counter-current to the rich feed stream, (iii) the semi-lean absorbent is introduced into the absorption column at a point between the rich feed stream and the lean absorbent stream and moves toward the bottom of the column counter-current to the rich feed stream, and (iv) the lean feed stream is recovered from the upper portion of the column, and the rich absorbent is recovered from the lower portion of the column and sent through the transition step to the regeneration step.

### FIELD

This invention relates to the field of chemical processes.

### INTRODUCTION

A reforming process makes synthesis gas from methane or other carbon and hydrocarbon feedstocks. Reformers can be steam methane reformers, autothermal reformers, or partial oxidation reactors. Synthesis gas contains primarily hydrogen, carbon monoxide, and carbon dioxide. Many reforming processes also contain water gas shift reactors, applied after the reforming reactor, which convert most of the carbon monoxide in the synthesis gas into carbon dioxide and more hydrogen. See, for example, Mendes et al., “The Water Gas Shift Reaction: From Conventional Catalytic Systems to Pd-based Membrane Reactors—a Review”, 5 Asia-Pac. J. Chem Eng. at 111-137 (2010). The water gas shift reaction produces a gas stream that contains high concentrations of carbon dioxide, such as a combination of hydrogen, carbon monoxide and up to 60 mole percent of carbon dioxide. In reforming processes, carbon dioxide is removed from the gas stream to provide an enriched hydrogen stream. The carbon dioxide removal step is commonly performed after a water gas shift step, but it may also be performed in reforming processes that do not have water gas shift reactors.

Conventional carbon dioxide recovery systems capture carbon dioxide from the carbon dioxide rich gaseous feed stream (“rich feed stream”) using an aqueous absorbent solution in three steps:
a) In an absorption step, the rich feed stream is contacted with the aqueous absorbent in an absorption column under an absorption temperature and an absorption pressure so that carbon dioxide is absorbed from the rich feed stream into the aqueous absorbent. The gaseous feed stream with reduced carbon dioxide, called the “lean feed stream”, is recovered from the upper part of the absorption column. The aqueous absorbent containing increased levels of carbon dioxide, called the “rich absorbent”, is recovered from the lower part of the absorption column.
b) In a regeneration step, the rich absorbent is subjected to a regeneration pressure lower than the absorption pressure and/or a regeneration temperature higher than the absorption temperature in a regeneration column, such that carbon dioxide gas is desorbed. Desorbed carbon dioxide is recovered from the upper portion of the regeneration column and sent for further processing. The aqueous absorbent, with carbon dioxide desorbed, is called “lean absorbent’ and is returned to the absorption step.
c) In a transition step, (i) the rich absorbent passing from the absorption step to the regeneration step is heated and depressurized to prepare for the regeneration step and (ii) the lean absorbent passing from the re and pressurized to prepare for the absorption step. Usually the heating and cooling is managed, at least in part, by passing the generation step to the absorption step is cooled rich absorbent and the lean absorbent through a primary heat exchanger, which transfers heat from the lean absorbent to the rich absorbent.
   Examples of this process are illustrated in U.S. Pat. Nos. 1,783,901; 5,853,680; 6,497,852; 8,303,685; 8,398,749; and 8,795,415.

The conventional process yields a low pressure carbon dioxide stream, which is frequently compressed by a series of compressors to a high pressure such as 75 to 150 bar at which it can be effectively stored or transferred. The compressors are expensive, with high capital cost and high energy consumption.

In a refinement to the conventional process, the regeneration step is carried out on two stages: first a high pressure stage followed by a low pressure stage. See, for example, PCT Publication WO2021/250083 A1 and Australian Patent 728167 B2. The low pressure regeneration produces a low pressure carbon dioxide stream with a pressure of 3 bar or less, as in a conventional process. The high pressure regeneration recovers a significant part of the carbon dioxide in a high pressure stream of 3 bar or more. The high pressure stream can skip one or two stages of compression, so that the first one or two compression stages use smaller cheaper compressors and less energy.

In spite of this refinement, the over-all process remains capital- and energy-intensive. It is desirable to make further improvements that reduce capital and energy cost.

### SUMMARY

One aspect of the present invention is a process to recover carbon dioxide from a gaseous feed stream that contains at least 1 bar of partial pressure of carbon dioxide, called the “rich feed stream,” using an aqueous liquid absorbent that absorbs carbon dioxide, called the “absorbent”, which process comprising the following steps:
a) an absorption step that takes place in an absorption column wherein rich feed stream is contacted with absorbent at an absorption temperature of no more than 100 °C and an absorption pressure of at least 8 bar for a period of time such that carbon dioxide is absorbed from the rich feed stream into the aqueous absorbent to produce a gaseous feed stream than contains reduced carbon dioxide, called the “lean feed stream”, and an absorbent containing increased levels of carbon dioxide, called the “rich absorbent”; and
b) a regeneration step wherein the rich absorbent from the absorption step is subjected to a regeneration pressure lower than the absorption pressure and a regeneration temperature higher than the absorption temperature for a period of time such that carbon dioxide is desorbed from the absorbent and recovered, to form a lean absorbent that contains less carbon dioxide than the rich absorbent and is returned to the absorption step; and
c) a transition step wh [symbol] sorption step to the regeneration step is heated and depressurized to prepare for the regeneration step and (ii) the lean absorbent passing from the regeneration step to the absorption step is cooled and pressurized to [symbol] rein (i) the rich absorbent passing from the ab [symbol] prepare for the absorption step, which transition step includes transferring heat from the lean absorbent to the rich absorbent in one or more heat exchangers,
   characterized in that:
1) The regeneration step comprises at least:
   (i) a high pressure regeneration stage, in which carbon dioxide is partially desorbed from the rich absorbent at a temperature from 80 to 140 °C and a pressure of from 3 to 40 bar(a) in a separator which is either a flash drum or an in-line separator, to provide a (A) high pressure carbon dioxide stream with a pressure of at least 3 bar and (B) a semi-lean absorbent that contains no more than 90 percent of the carbon dioxide loading of the rich absorbent, and
   (ii) a low pressure regeneration stage, in which further carbon dioxide is desorbed from a portion of the semi-lean absorbent in a regeneration column at a temperature higher than the temperature of the high pressure regeneration and a pressure lower than the pressure of the high pressure regeneration, to provide (A) a low pressure carbon dioxide stream with a pressure lower than the high pressure carbon dioxide stream and (B) the lean absorbent stream, which contains no more than 50 percent of the carbon dioxide loading of the rich absorbent; and
2) the semi-lean absorbent from the high pressure regeneration stage is split, with part of the semi-lean absorbent sent to the low pressure regeneration and part of the semi-lean absorbent returned through the transition step to the absorption step; and
3) in the absorption step: (i) the rich feed stream is introduced into the absorption column in a lower portion of the absorption column and moves toward the top of the column, (ii) the lean absorbent is introduced into the absorption column in an upper portion of the column and moves toward the bottom of the column counter-current to the rich feed stream, (iii) the semi-lean absorbent is introduced into the absorption column at a point between the rich feed stream and the lean absorbent stream and moves toward the bottom of the column counter-current to the rich feed stream, (iv) the lean feed stream is recovered from the upper portion of the absorption column, and (v) the rich absorbent is recovered from the lower portion of the absorption column.

A second aspect of the present invention follows the first aspect, and in addition:
the rich feed stream enters the process at a temperature of at least 140 °C;
heat from the rich feed stream heats the rich absorbent in at least two points of the transition or regeneration step before the rich feed stream is introduced into the absorption column.

A third aspect of the present invention follows the first or second aspect, and in addition the aqueous absorbent is a hybrid aqueous absorbent that contains water, a physical organic absorbent for carbon dioxide that is miscil [symbol] nt for carbon dioxide that is miscible with water. [symbol] le with water, and a chemical organic absorbe

[symbol]

The high pressure regeneration provides a high pressure carbon dioxide stream, which reduces capital and energy cost during compression, as previously described. Performing the high pressure regeneration in a flash-drum or inline separator reduces capital cost as compared to a high pressure regeneration column.

Flash drums and in-line separators also reduce the residence time of the rich absorbent in the high pressure regeneration as compared to a high pressure regeneration column, which reduces the heat exposure of the absorbent. Further, performing the high pressure regeneration at a pressure from 3 to 40 bar(a) and a temperature from 90 to 140 °C recovers substantial quantities of high pressure carbon dioxide in the high pressure regeneration stage, while minimizing heat exposure and loading of the absorbent. High heat exposure and loading is known to degrade the absorbent.

Recycling a portion of the semi-lean absorbent to the absorption step without going through the low pressure regeneration stage reduces the size and power consumption of the low pressure regeneration column and reduces the heat exposure of the absorbent. Using heat from the rich feed stream to provide heat in the transition or regeneration stages reduces power consumption.

Hybrid absorbents improve the release of carbon dioxide in the high pressure regeneration stage at moderate temperatures and improve the absorption of carbon dioxide by the absorbent, thereby reducing heat exposure of the absorbent and improving performance of the process.

Combining these refinements significantly reduces the equipment cost, power consumption and absorbent cost for the over-all carbon dioxide recovery process.

### BRIEF DESCRIPTION OF THE DRAWINGS

FIG. 1 shows an apparatus for practicing the claimed invention which yields three carbon dioxide streams: a high pressure carbon dioxide stream, a medium pressure carbon dioxide stream and a low pressure carbon dioxide stream; and which recovers heat from the rich feed stream at two points in the regeneration step.

FIG. 2 shows an apparatus for practicing the claimed invention which yields three carbon dioxide streams: a high pressure carbon dioxide stream, a medium pressure carbon dioxide stream and a low pressure carbon dioxide stream; and which recovers heat from the rich feed stream at one point in the regeneration step and one point in the transition step.

FIG. 3 shows an apparatus for practicing the claimed invention which yields three carbon dioxide streams: a high pressure carbon dioxide stream, a medium pressure carbon dioxide stream and a low pressure carbon dioxide stream; which recovers heat from the rich feed stream at two points in the regeneration step; and which recovers heat from the high pressure carbon-dioxide stream at one point in the transition step.

FIG. 4 shows an a [symbol] which yields three carbon dioxide streams: a high pressure carbon dioxide stream, a medium pressure carbon dioxide stream and a low pressure carbon dioxide stream; which recovers heat from the rich feed stream at two points in the [symbol] pparatus for practicing the claimed invention [symbol] regeneration step and one point in the transition step; and which recovers heat from the high pressure carbon-dioxide stream at one point in the transition step.

### DETAILED DESCRIPTION

The process of this invention recovers carbon dioxide from a gaseous feed stream using a liquid absorbent. In some embodiments, the feed stream may contain hydrogen or methane or ethane or propane or natural gas or ethylene or propylene or carbon monoxide or other combustion products.

Before the feed stream enters the absorption step, it contains carbon dioxide with a partial pressure of at least 1 bar and is called a “rich feed stream”. In some embodiments, the partial pressure of carbon dioxide in the rich feed stream is at least 2 bar or at least 3 bar or at least 4 bar or at least 5 bar. There is no critical limit on the maximum partial pressure of carbon dioxide in the rich feed stream, but partial pressures above 60 bar or 30 bar may be unnecessary. In some embodiments, the pressure is low enough that the carbon dioxide does not liquify.

In some embodiments, the rich feed stream contains at least 5 mole percent carbon dioxide or at least 10-mole percent carbon dioxide or at least 15 mole percent or at least 20 mole percent. In some embodiments, the rich feed stream further comprises at least 40 mole percent hydrogen or at least 50 mole percent or at least 60 mole percent. The

In some embodiments, the rich feed stream is produced in a water gas shift process. See, for example, Mendes et al., “The Water Gas Shift Reaction: From Conventional Catalytic Systems to Pd-based Membrane Reactors—a Review”, 5 Asia-Pac. J. Chem Eng. at 111-137 (2010). The water gas shift process often makes a stream that contains:
Hydrogen: At least 40 mole percent or at least 50 mole percent or at least 60 mole percent or at least 70 mole percent. At most 90 mole percent or at most 80 mole percent or at most 75 mole percent.
Carbon dioxide: At least 10 mole percent or at least 15 mole percent. At most 60 mole percent or at most 50 mole percent or at most 30 mole percent or at most 25 mole percent.
Other impurities (such as unreacted hydrocarbon, carbon monoxide, nitrogen, sulfur oxides, nitrogen oxides, hydrogen sulfide, argon and methanol): From 0 to 10 mole percent or from 1 to 5 mole percent.

In some embodiments, the rich feed stream has a temperature of at least 150 °C or at least 180 °C. In some embodiments, the rich feed stream has a temperature of at most 220 °C or at most 200 °C or at most 190 °C. For example, the feed stream from a water gas shift process may have a temperature between 180 °C and 220 °C.

The carbon dioxide is recovered in two or more streams which are at different pressures.
In some embodime [symbol] treams: a low pressure stream which has a pressure of no more than 3 bar and a high pressure stream which has a pressure of at least 3 bar. [symbol] ts, the carbon dioxide is recovered in in two s [symbol]
In some embodiments, the carbon dioxide is recovered in three streams: a low pressure stream which has a pressure of no more than 3 bar, a medium pressure stream which has a pressure higher than the low pressure stream, and a high pressure stream which has a pressure higher than the medium pressure stream.

The process uses three steps as previously described: an absorption step, a regeneration step and a transition step. Each process steps uses an aqueous liquid absorbent, called the “absorbent”. In some embodiments, the absorbent contains one or more additives that enhance the absorption or desorption of carbon dioxide and are miscible with water.

Some additives to the absorbent may be chemical absorbents, meaning that the carbon dioxide undergoes a reversible chemical reaction with the additives. In some embodiments, the additives are organic amines. Examples of organic amines meet Formula 1:

NRₐH_{b} (1)

wherein each R is independently an organic moiety, a is a number of organic moieties from 1 to 3, and b is a number of hydrogen atoms from 1 to 2.
The organic amine may be a primary amine (a=1 and b=2) or a secondary amine (a=2 and b=1) or a tertiary amine (a=3 and b=0).
In some embodiments, each R group is independently an alkyl group or an alkanol group. In some embodiments, each R group contains on average at least 1 carbon atom or at least 2 carbon atoms. In some embodiments, each R group contains on average at most 6 carbon atoms or at most 4 carbon atoms or at most 3 carbon atoms or at most 2 carbon atoms.
In some embodiments, two R groups are linked to each other to form a cyclic structure such a piperidine, a pyrrolidine or a piperazine structure.
In some embodiments, the organic amine comprises two different R groups such an at least one alkyl group and at least one alkanolamine group.
   Examples of suitable organic amines include ethanolamine, diethanolamine, triethanolamine, n-methyl diethanolamine (MDEA), piperazine and pyrrolidine. Suitable organic amines are commercially available.

Some additives to the absorbent may be physical absorbents, meaning that the additive causes carbon dioxide to physically blend with the absorbent but does not chemically react with the carbon dioxide. Examples of physical absorbents include:
low molecular weight polyalkylene glycols and their mono-ethers di(propylene glycol), tri(propylene glycol), di(ethylene glycol), tri(ethylene glycol), tetra(ethylene glycol) and their monomethyl, monoethyl, and mono-t-butyl ethers such as methoxytriglycol;
cyclic sulfones such as sulfolane,
thiodiglycol and
glycerin.

Examples of polyalkylene glycols and their mono-ethers meet Formula 2

HO—(—CH₂CHR¹—O—)_{c}—R² (2)

wherein each of R¹ and R² is independent a hydrogen atom or an alkyl group and c is a number of repeating alkylene glycol units.
In some embodiments, each R¹ contains on average no more than 5 carbon atoms or no more than 3 carbon atoms or no more than 2 carbon atoms or no more than 1 carbon atom. In some embodiments, each R¹ is a methyl group or a hydrogen atom. In some embodiments, each R¹ is a hydrogen atom.
In some embodiments, each R² contains on average no more than 6 carbon atoms or no more than 4 carbon atoms or no more than 3 carbon atoms or no more than 2 carbon atom. In some embodiments, each R² is a methyl group or a hydrogen atom. In some embodiments, each R² is a methyl group.
In some embodiments, c is on average at least 1 or at least 2 or at least 2.5 or at least 2.8. In some embodiments, c is on average at most 8 or at most 6 or at most 5 or at most 4 or at most 3.5 or at most 3.2.
   Suitable physical absorbents are commercially available under the DOWANOL™, CARBITOL™ and UCARSOL™ trademarks.

In some embodiments, the absorbent contains both chemical absorbent and physical absorbent (called “hybrid absorbent”). For example, the absorbent may contain:
polyalkylene glycol or its mono-ether as previously described. In some embodiments, the hybrid additives contain 10 to 50 weight percent polyalkylene glycol or its mono-ether.
one or more alkanolamines as previously described. In some embodiments, the hybrid absorbent additives contain 20 to 70 weight percent alkanolamine.
optionally one or more cyclic amine as previously described. In some embodiments, the hybrid absorbent additives contain 0 to 30 weight percent cyclic amine.
   Suitable hybrid additive packages are commercially available under the UCARSOL™ trademark.

In some embodiments, the absorbent contains at least 15 weight percent water or at least 20 weight percent or at least 24 weight percent, based solely on the weight of water and additives and excluding any absorbed carbon dioxide. In some embodiments, the aqueous absorbent contains at least 25 weight percent additives or at least 40 weight percent or at least 50 weight percent or at least 60 weight percent, based solely on the weight of water and additives and excluding any absorbed carbon dioxide.

### Absorption Step

In the absorption step, the rich feed stream is contacted with absorbent in an absorption column with the absorbent running c [symbol] ed stream is introduced into a lower portion of the column and flows toward the top. Two absorbent streams are introduced to the [symbol] counter-current to the feed stream. The rich fe [symbol] absorption column at two different points. Lean absorbent is introduced into an upper portion of the column and flows toward the bottom. Semi-lean absorbent is introduced into the column between the lean absorbent and the rich feed stream, and also flows toward the bottom of the column.

The lean absorbent contains a lower loading of carbon dioxide than the rich absorbent or the semi-lean absorbent. (“Loading” means the total moles of carbon dioxide divided by the total moles of amine in the absorbent.) In some embodiments, the lean absorbent contains no more than a 0.2 mole-per-mole loading of carbon dioxide or no more than 0.1 or no more than 0.08. There is no minimum desired loading for the lean absorbent; the loading of carbon dioxide may be undetectable (essentially 0). In some embodiments, the lean absorbent contains at least 0.01 loading of carbon dioxide or at least 0.02 or at least 0.05.

The semi-lean absorbent contains a lower loading of carbon dioxide than the rich absorbent and a higher loading of carbon dioxide than the lean absorbent. In some embodiments, the semi-lean absorbent contains no more than 0.5 loading of carbon dioxide or no more than 0.4 loading or no more than 0.3 loading. In some embodiments, the semi-lean absorbent contains at least 0.05 loading of carbon dioxide or at least 0.1 loading of carbon dioxide or at least 0.15 loading.

The lean and semi-lean absorbents absorb carbon dioxide from the rich feed stream, producing a lean feed stream and rich absorbent. The rich absorbent is recovered in the lower portion of the absorption column, such as at or near the bottom of the column. The lean feed stream exits the absorption column in the upper portion of the column, such as at or near the top of the column, and is recovered for further use or storage. The rich absorbent proceeds toward the transition step and then the regeneration step.

The semi-lean absorbent is introduced into the absorption column between the points where the rich feed stream is introduced and where the lean absorbent is introduced. In some embodiments, the semi-lean absorbent is introduced into the absorption column at least 20 percent of the tower height below the lean absorbent stream, based on the distance between the lean absorbent and the rich feed stream introduction points, or at least 30 percent below or at least 40 percent below. In some embodiments, the semi-lean absorbent is introduced into the absorption column at most 80 percent of the tower height below the lean absorbent stream, based on the distance between the lean absorbent and the rich feed stream introduction points, or at most 70 percent below or at most 60 percent below.

Conditions in the absorption column are selected to encourage absorption of the carbon dioxide from the feed stream into the absorbent. In some embodiments, the absorption column has packing and/or trays to extend the contact of the rich feed stream and the absorbent. Examples of useful packing include random packing or structured packing.

The optimum pressure and temperature for the absorption step vary depending on the absorbent. It is known as a general rule [symbol] ture encourage absorption.

The pressure in the absorption column (absorption pressure) is at least 8 bar. In some embodiments, the absorption pressure is at least 10 bar or at least 12 bar or at least 14 bar. In some [symbol] that increasing pressure and reducing tempera [symbol] embodiments, the absorption pressure is at most 100 bar or at most 80 bar or at most 70 bar or at most 60 bar or at most 50 bar.

The temperature in the absorption column (absorption temperature) is at most 100 °C. In some embodiments, the absorption temperature is at most 90 °C or at most 80 °C or at most 70 °C or at most 60 °C or at most 55 °C or at most 50 °C. In some embodiments, the absorption temperature is greater than 0 °C or at least 10 °C or at least 20 °C or at least 30 °C.

Maintaining the desired absorption temperature may require supplemental cooling. For example, if the rich feed stream is above the absorption temperature when it approaches the absorption column, it may be passed through one or more coolers to reduce temperature. The lean and semi-lean absorbents have been cooled in one or more heat exchangers during the transition step as they move from the regeneration step to the absorption step, but they may also receive supplemental cooling before they enter the absorption column. In addition, a supplemental cooler, called an intercooler, may be added to absorption column; a fraction of the absorbent is withdrawn from the column, cooled in the intercooler, and then returned to the column at a lower temperature. A similar result may be achieved via a pumparound, wherein a fraction of the rich absorbent leaving the absorption column is split from the main stream, cooled, and fed back into the absorption column with the semi-lean stream feed point or below it.

The lean feed stream is recovered at or near the top of the absorption column. In some embodiments, the absorption step captures at least 90 percent of the carbon dioxide in the rich feed stream, or at least 95 percent or at least 98 percent or at least 99 percent or at least 99.5 percent or at least 99.8 percent. There is no maximum desired capture of carbon dioxide, but in some embodiments, the lean feed stream may retain at least 0.001 percent of the carbon dioxide in the rich feed stream (99.999 mole percent capture) or at most 0.01 percent (99.00 mole percent capture).

The rich absorbent leaving the absorption column contains higher loading of carbon dioxide than the lean absorbent and the semi-lean absorbent. In some embodiments, the rich absorbent contains at least 0.3 loading of carbon dioxide or at least 0.4 loading of carbon dioxide or at least 0.5 loading of carbon dioxide. In some embodiments, the rich absorbent contains no more than 1.0 loading of carbon dioxide or no more than 0.8 loading or no more than 0.7 loading. The temperature and pressure of the rich absorbent are about the same as the absorption temperature and the absorption pressure.

The rich absorbent proceeds from the absorption step through the transition step and to the regeneration step.

### Regeneration Step

The regeneration step (desorption of carbon dioxide from the absorbent) is carried out in at least two stages, which include a high pressure regeneration and a low pressure regeneration. In some embodiments, the regenerati [symbol] ich include a high pressure regeneration, one or more medium pressure regenerations and a low pressure regeneration. It is known that increasing temperature and decreasing pressure encourage desorption of carbon dioxide from the [symbol] on step takes place in three or more stages, w [symbol] absorbent. Generally, each regeneration stage subjects the absorbent to a higher temperature or lower pressure or both, as compared to the previous stage.

The high and medium pressure regenerations are flash distillations. Carbon dioxide in the rich feed stream is rapidly desorbed and vaporized by a pressure drop in a flash separator. The flash separators are each independently a flash drum or an in-line separator. Unlike a multi-stage distillation column, flash separators do not have a gas-liquid contacting section that contains trays or packing to facilitate gas-liquid mass transfer. Rather, the flash separators rely on gravitational forces (flash drums and other traditional separators) or centrifugal forces (inline separators) to facilitate gas-liquid separation.

The high pressure regeneration takes place at a temperature from 80 °C to 140 °C and a pressure of from 3 bar to 40 bar. The rich absorbent stream entering the high pressure regeneration has been heated in the transition step, so in most embodiments, the temperature of the high pressure regeneration is higher than the absorption temperature. In some embodiments, the temperature of the rich absorbent entering the high pressure regeneration is at least 90 °C or at least 100 °C. In some embodiments, the temperature of the rich absorbent entering the high pressure regeneration is at most 130° Cor at most 120 °C or at most 115 °C.

In some embodiments, the pressure of the rich absorbent in the high pressure regeneration is at least at least 3 bar or at least 5 bar or at least 8 bar or at least 10 bar or at least 12 bar. In some embodiments, the pressure of the rich absorbent in the high pressure regeneration is at most 30 bar or at most 20 bar or at most 18 bar or at most 16 bar. In most embodiments, the pressure of the high pressure regeneration is no higher than the absorption pressure or is below the absorption pressure.

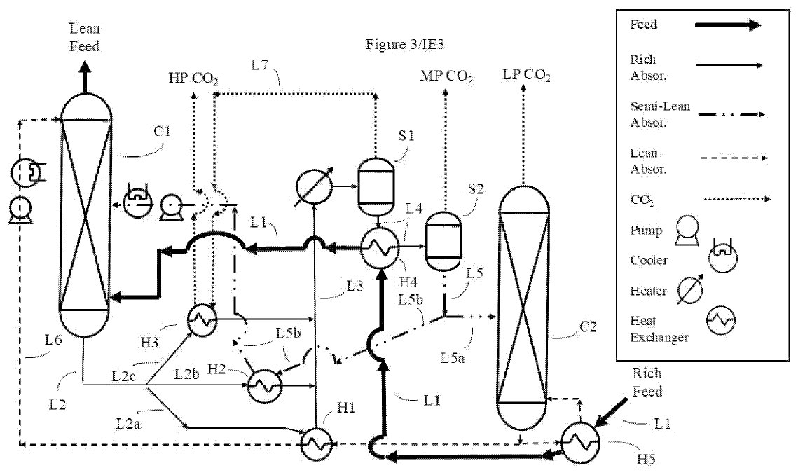

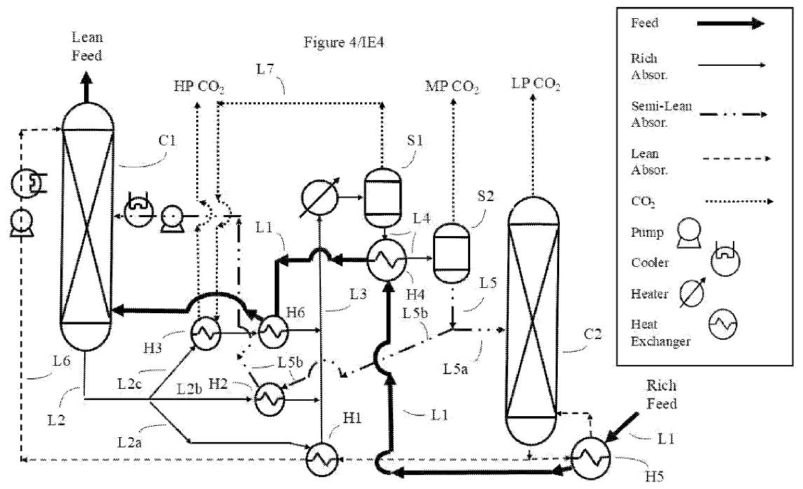

The high pressure regeneration produces a semi-lean absorbent and a high pressure carbon dioxide stream. The high pressure carbon dioxide stream has roughly the same temperature and pressure as the conditions of the high pressure regeneration. It may be recovered and sent directly to the compression or other use. Alternatively, heat may be recovered from the high pressure carbon dioxide stream before it is sent on, as described below for heat integration and as shown in FIGS. 3 and 4.

In some embodiments, one or more medium pressure regenerations may be carried out on the semi-lean absorbent after it leaves the high pressure regeneration and before it enters the low pressure regeneration. The medium pressure regenerations are carried out at pressures lower than the high pressure regeneration but higher than the low pressure regeneration. In some embodiments, the pressure in the medium pressure regeneration is at least 3 bar or at least 4 bar or at least 5 bar or at least 6 bar. In some embodiments, the pressure in the medium pressure regeneration is at most 15 bar or at most 12 bar or at most 10 bar or at most 9 or at most 8 bar. For example, high pressure regeneration may be carried out at a pressure from 10 to 20 bar and medium pressure regeneration may be carried out at a pressure from 5 to 10 bar, or high pressure regeneration may be carried out at a pressure from 12 to 15 bar and medium pressure regenerati

[symbol]

In some embodiments, the semi-lean absorbent is heated before it enters the medium pressure regeneration. For example, as described below for heat integration, a heat exchanger may heat the semi- [symbol] on may be carried out at a pressure from 6 to 9 [symbol] lean absorbent with heat from the rich feed stream. In some embodiments, the temperature of the semi-lean absorbent entering the medium pressure regeneration is at least 80 °C or at least 90 °C or at least 95 °C or at least 100 °C. In some embodiments, the temperature of the semi-lean absorbent entering the medium pressure regeneration is at most 140 °C or at most 130 °C or at most 125 °C. For example, high pressure regeneration may be carried out at a temperature from 90 to 120 °C and medium pressure regeneration may be carried out at a temperature from 100 to 130.

The medium pressure regeneration produces a medium pressure carbon dioxide stream and a stream of semi-lean absorbent with reduced carbon dioxide content. The pressure of the medium pressure carbon dioxide stream corresponds roughly to the pressure of the medium pressure regeneration. The medium pressure carbon dioxide stream is recovered for use or storage. In many embodiments, it is sent to be compressed to a higher pressure.

The semi-lean absorbent from the high pressure regeneration or the medium pressure regeneration is split into two streams that go to different uses. Part of the semi-lean absorbent is sent to the low pressure regeneration, and part of the semi-lean absorbent is returned through the transition step to the absorption step. As previously described, the semi-lean absorbent returned to the absorption step is introduced into the absorption column between the lean absorbent and the rich feed stream. In some embodiments, at least 2 percent of the semi-lean absorbent is sent to the low pressure regeneration, or at least 4 percent or at least 8 percent or at least 12 percent. The remaining semi-lean absorbent (at most 98 percent or 96 percent or 92 percent or 88 percent) is returned through the transition step to the absorption step. In some embodiments, at most 80 percent of the semi-lean absorbent is sent to the low pressure regeneration, or at most 60 percent or at most 50 percent or at most 40 percent or at most 30 percent or most 26 percent or at most 20 percent. The remaining semi-lean absorbent (at least 20 percent or 40 percent or 50 percent or 60 percent or 70 percent or 74 percent or 80 percent) is returned through the transition step to the absorption step.

In low pressure regeneration, further carbon dioxide is desorbed as a gas from the semi-lean absorbent.

The low pressure regeneration step takes place in a regeneration column. Known columns can be used, such as a packed or trayed column. In some embodiments, the absorbent and the carbon dioxide stream move counter-currently through the column; for example the semi-lean absorbent is introduced from the middle to the top of the column, the lean absorbent is recovered at the bottom of the column, and the low pressure carbon dioxide stream is recovered near the top of the column.

Conditions in the low pressure regeneration step are selected to encourage desorption of the carbon dioxide from the absorbent, without substantially degrading the absorbent. The low pressure regeneration takes place at a regeneration temperature that is at least as high as the temperature of high pressure and medium pressu [symbol] that is lower than the pressure in the high pressure and medium pressure regeneration. [symbol] re regeneration and at a regeneration pressure

[symbol]

In some embodiments, the low pressure regeneration pressure is at most 5 bar, or at most 4 bar or at most 3 bar or at most 2 bar or at most 1 bar. In some embodiments, the low pressure regeneration pressure is at least 0.5 bar or at least 0.8 bar or at least 0.9 bar or at least 1 bar.

In some embodiments, the low pressure regeneration temperature is at least 90 °C or at least 100 °C or at least 110 °C. In some embodiments, the regeneration temperature is at most 150 °C or at most 140 °C or at most 135 °C. In some embodiments, temperature in the low pressure regeneration may be kept below the maximum temperature in order to reduce the heat exposure of the absorbent.

In order to maintain appropriate temperature in the regeneration column, the semi-lean absorbent may receive supplemental heat before or during the regeneration step. Additional heat may be supplied by known means, such as a reboiler, a heating jacket or a heating coil. In one embodiment, a reboiler heats a portion of the lean fluid stream leaving the regeneration step and recycles it to the regeneration step. In some embodiments, additional heating in the reboiler is provided in whole or in part using heat from the rich feed stream.

In some embodiments, some water in the absorbent may vaporize in the low pressure regeneration step. It may be desirable for water to vaporize because it can act as a stripping gas. A condenser may be used to avoid losing the vaporized absorbent. The condenser may be located at or near the top of the regeneration column.

The carbon dioxide is recovered from the regeneration step as a “low pressure carbon dioxide stream” having a pressure roughly similar to the regeneration pressure in the regeneration column.

In some embodiments, at least 40 percent of the carbon dioxide that is recovered in the process is recovered in the high and medium pressure streams, or at least 50 percent or at least 60 percent or at least 70 percent or at least 80 percent or at least 85 percent. The remaining carbon dioxide (at most 60 percent or at most 50 percent or at most 40 percent or at most 30 percent or at most 20 percent or at most 15 percent) is recovered in the low pressure stream. There is no maximum desired recovery in the high and medium pressure carbon dioxide stream(s), but in some embodiments it may be inefficient to recover more than 95 percent of the carbon dioxide in the high and medium pressure streams and less than 5 percent in the low pressure stream.

### Transition Step

In the transition step, the absorbent passes back and forth between the absorption step and the regeneration step.

As previously described, the regeneration step takes place at a higher temperature than the absorption step. Rich absorbent leaving the absorption step is heated in the transition step to prepare for regeneration. Lean and semi-lean absorbent leaving the regeneration step are cooled in the transition step to prepare for the absorption step. At least part of the heating and cooling are accomplished by heat exchangers that transfer hea [symbol] rich absorbent. Examples of suitable heat exchangers include shell & tube, plate & frame, or plate & shell exchangers. [symbol] t from the lean and semi-lean absorbent to the

[symbol]

In some embodiments, the rich absorbent in the transition step is separated into at least two separate streams. The first stream of rich absorbent receives heat from the lean absorbent in a first heat exchanger. The second stream of rich absorbent receives heat from the semi-lean absorbent in a second heat exchanger.

In some embodiments, the rich absorbent in the transition step is separated into at least three separate streams. The first stream of rich absorbent receives heat from the lean absorbent in a first heat exchanger. The second stream of rich absorbent receives heat from the semi-lean absorbent in a second heat exchanger. The third stream of rich absorbent receives heat from the rich feed stream in a third heat exchanger.

After leaving the heat exchangers, the separated rich absorbent streams are recombined. In some embodiments, supplementary heaters may provide additional heating for the rich absorbent downstream from the heat exchangers. In some embodiments, supplementary coolers may provide additional cooling for the lean absorbent and the semi-lean absorbent downstream from the heat exchangers.

As previously described, the regeneration step takes place at a lower pressure than the absorption step. In the transition step, pumps raise the pressure of the lean absorbent and the semi-lean absorbent to the absorption pressure before they enter the absorption step. In some embodiments, multiple pumps may be used to increase pressure stepwise. The pumps may be located upstream or downstream of the heat exchangers or both. Examples of suitable pumps include centrifugal, positive displacement, regenerative turbine, axial flow, and ejector pumps.

Likewise, in the transition step, one or more pressure-reducing valves may reduce the pressure of the rich absorbent from the absorption pressure before it enters the regeneration step. Examples of suitable pressure-reducing valves include globe valves, diaphragm valves, gate valves, and needle valves.

### Compression of the Carbon Dioxide Streams

The process of this invention yields a high pressure carbon dioxide stream and a low pressure carbon dioxide stream and optionally one or more medium pressure carbon dioxide streams. In some embodiments, these streams are compressed to a pressure suitable for use, storage or transportation. In some embodiments, the target pressure for the recovered carbon dioxide is at least 40 bar or at least 45 bar or at least 50 bar or at least 55 bar or at least 60 bar. In some embodiments, the target pressure for the recovered carbon dioxide is at most 200 bar or at most 150 bar or at most 100 bar or at most 80 bar. In some embodiments, the carbon dioxide is a liquid or supercritical fluid at the target pressure and 25 °C.

The compression may be performed using a series of two or more compressors to increase the pressure of the carbon dioxide stepwise to the target pressure. The number of compressors depends on the target pressure and the efficiency of the compressors. In some embodiments, each compressor increases the pressure of the carbon dioxide by at least 1.5 times or at least 2.0 times or at least 2.5 times. In some embodiments, each [symbol] n dioxide by at most 5 times or at most 4 times or at most 3 times. [symbol] compressor increases the pressure of the carb

[symbol]

In some embodiments, the compression is carried out using at least 2 compression stages or at least 3 compression stages or at least 4 compression stages. In some embodiments, the compression is carried out using no more than 8 compression stages or no more than 7 compression stages or no more than 6 compression stages or no more than 5 compression stages. For example, if the low pressure carbon dioxide stream is from 1 to 2 bar, a first compression stage can increase pressure to 3 to 5 bar, a second compression stage can increase pressure to 6 to 13 bar, a third compression stage can increase pressure to 15 to 30 bar, and a fourth compression stage can increase pressure to 40 to 80 bar.

The medium pressure and high pressure carbon dioxide streams may be introduced into the compression process at higher stages than the low pressure carbon dioxide stream. As a result, the lower stage compressors can be smaller and use less energy. For example, when the compression step uses the four stages previously described, a high pressure carbon dioxide stream at 12 to 15 bar can be introduced into the third or fourth compression stage, and a medium pressure carbon dioxide stream at 6 to 9 bar can be introduced into the third compression stage. When the low-pressure stream contains only 5 to 15 percent of the carbon dioxide, the capacity and power consumption of the first and second compression stages may be reduced by more than 80 percent.

### Heat Integration

As described, the rich feed stream may enter the process at a temperature of at least 150 °C or at least 180 °C or at least 200 °C, such as from a water gas shift process. Since the absorption temperature is lower than the temperature of the rich feed stream, the rich feed stream must be cooled before entering the absorption step. The heat of the rich feed stream may be useful to heat the absorbent in the regeneration step or in the transition step or both.

The following points of the process, among others, can recover and use heat from the rich feed stream:
in a reboiler that heats contents of the low pressure regeneration column;
in a heat exchanger that heats rich absorbent before the high pressure regeneration;
in a heat exchanger that heats semi-lean absorbent before a medium pressure regeneration; and
in a heat exchanger that heats semi-lean absorbent before the low pressure regeneration.
   In some embodiments, heat is recovered from the rich feed stream in at least two of these points. In some embodiments, heat is recovered from the rich feed stream in three of these points. In some embodiments, heat is recovered from the rich feed stream in four of these points. In some embodiments, one of the points where heat is recovered is a reboiler for the low pressure regeneration column. In some embodiments, heat is recovered in the reboiler and before the high pressure regeneration. In some embodiments, heat is recovered in the reboiler and before the medium pressure regeneration. In some embodiments, heat is recovered in the reboiler and before the high and medium pressure regenerations.

In addition, the high [symbol] gh pressure regeneration may have a temperature of 140 °C. It may be advantageous to recover heat from this stream before sending the [symbol] pressure carbon dioxide stream leaving the hi [symbol] stream to compression. This heat can advantageously be recovered into the rich absorbent using a heat exchanger before the high pressure regeneration.

### REFERENCE TO DRAWINGS

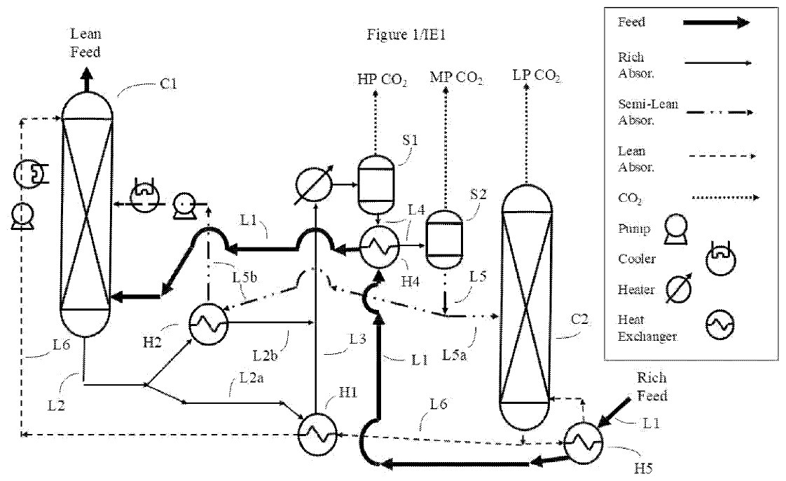

### FIG. 1:

FIG. 1 illustrates an example of the inventive process.

Column C1 is the absorption column. Column C1 has (a) an outlet for rich absorbent at the bottom of the column, (b) an inlet for rich feed stream at the lowest point of the gas-liquid contacting section, where the contacting section comprises packing or trays to facilitate gas-liquid mass transfer, (c) an inlet for semi-lean absorbent about 50 percent up the contacting section of the column, (d) an inlet for lean absorbent at the top of the contacting section, and (e) at outlet for lean feed at the top of the column. Column C1 contains Raschig Super Rings #2 packing. Optionally, a water wash may be included, which is an additional contacting section above the lean feed point designed to recover solvent from the gas by contacting it with water, which is returned to the solvent system at some location.

Column C2 is the regeneration column. Column C2 has (a) an outlet for lean absorbent at the bottom of the column, (b) an inlet for semi-lean absorbent about at or near the top of the contacting section, and (c) an outlet at the top of the column for recovering the desorbed carbon dioxide, with a condenser to recapture any vaporized absorbent. A reboiler (H5) at the bottom of Column C2 takes a portion of the lean absorbent, heats it, and returns it to Column C2 to maintain the regeneration temperature. Column C2 contains 2″ random packing.

S1 is a high pressure flash drum. S2 is a medium pressure flash drum. Each flash drum has an inlet for the rich absorbent, an outlet at the top for carbon dioxide and an outlet below the liquid line for absorbent that has been partially desorbed.

A rich feed stream contains about 25 mole percent hydrogen, about 74 mole percent carbon dioxide and less than 1 mole percent each of water, methane and carbon monoxide. The rich feed stream has a temperature of about 154 °C at the start of the process.

The rich feed stream enters the system through line L1. Line L1 carries the rich feed stream through heat exchangers H5 and then H4, to reduce the temperature of the rich feed stream to no more than 40 °C, and then introduces the rich feed stream near the bottom of absorption column C1. In some embodiments, the rich feed may also receive supplemental cooling through a cooler (not shown) before entering absorption column CL.

Lean absorbent (containing no more than 0.1 loading carbon dioxide) enters absorption column C1 near the top through line L6 at a temperature of no more than 40 °C. Semi-lean absorbent (containing from 0.1 to 0.5 loading carbon dioxide) enters absorption column C1 near the middle through line L5b at a temperature of [symbol] sorption column C1 has supplemental cooling (not shown). Carbon dioxide is absorbed from the rich feed stream into the semi-lean absorbent and the lean absorbent in column C1, producing the rich absorbent (containing at least 0.4 [symbol] no more than 40 °C. In some embodiments, a [symbol] loading of carbon dioxide) and the lean feed stream (containing less than 1 mole percent carbon dioxide). The lean feed stream exits from the top of column C1 and is recovered.

The rich absorbent leaves column C1 through Line L2 at a temperature of no more than 40 °C. Line L2 splits into two separate lines, labelled L2a and L2b. Line L2a carries part of the rich absorbent through heat exchanger H1, where it receives heat from the lean absorbent, and into line L3. Line L2b carries part of the rich absorbent through heat exchanger H2, where it receives heat from the semi-lean absorbent, and into line L3.

Line L3 carries the rich absorbent through a supplemental heater where it is heated to a temperature of at least 110 °C and then into flash drum S1. Pressures in flash drum S1 are from 10 to 20 bar, and high pressure carbon dioxide flashes off from the rich absorbent stream at that pressure. The high pressure carbon dioxide is recovered from the top of flash drum S1.

A semi-lean absorbent exits flash drum S1 via Line L4. Line L4 carries the semi-lean absorbent through a heat exchanger H4, where it receives heat from the rich feed stream and. Line L4 then carries the heated semi-lean absorbent into flash drum S2. Pressures in flash drum S2 are from 3 to 10 bar, and medium pressure carbon dioxide flashes off from the semi-lean absorbent stream at that pressure. The medium pressure carbon dioxide is recovered from the top of flash drum S2. The absorbent leaving flash drum S2 is semi-lean absorbent containing reduced levels of carbon dioxide, from 0.05 to 0.3 loading.

The semi-lean absorbent leaves flash drum S2 through line L5. Line L5 splits into lines L5a and L5b. Line L5a carries part of the semi-lean absorbent into regeneration column C2. Line L5b carries part of the semi-lean absorbent through heat exchanger H2, where it gives heat to the rich absorbent stream. From the heat exchanger H2, the semi-lean absorbent is pressurized to absorption pressure and cooled to absorption temperature and returned to absorption column C1 near the middle of the column.

Part of the semi-lean absorbent enters the regeneration column C2 via line L5a. Temperatures in the regeneration column are at least 100 °C, and pressure in the regeneration column is no more than 6 bar. Low pressure carbon dioxide desorbs from the semi-lean absorbent at that pressure, producing a lean absorbent and a low pressure carbon dioxide stream. The low pressure carbon dioxide exits the top of column C2 and is recovered. The lean absorbent leaves the column C2 though line L6. A side stream of lean absorbent is heated in heat exchanger H5 by heat from the rich absorbent stream, and is returned to column C2 to maintain heat in column C2.

The remainder of the lean absorbent is carried by line L6 through heat exchanger H1, where it heats to the rich absorbent. From the heat exchanger H1, the lean absorbent is pressurized to absorption pressure and cooled to absorption temperature and returned to absorption column C1 near the top of the column.

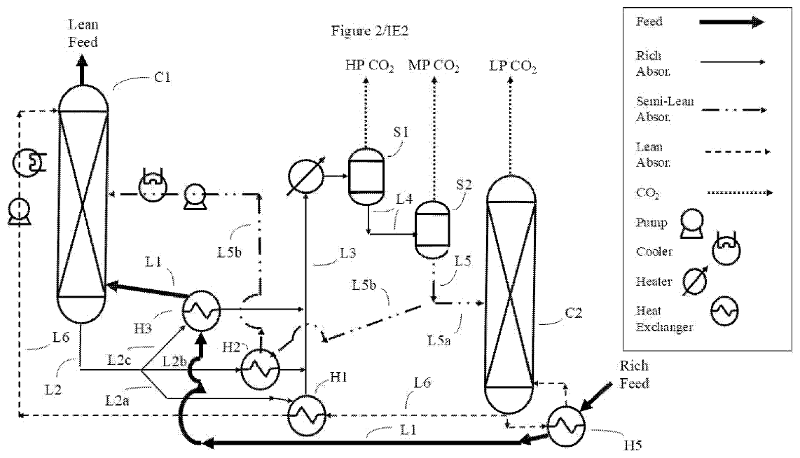

### FIG. 2:

FIG. 2 illustrates [symbol] h includes alternate heat integration. FIG. 2 proceeds like FIG. 1 except as follows. Line L2 splits into three separate lines L2a, L2b and L2c, each carrying rich absorbent. Lines L2a and L2b proceed as in FIG. 1. Line L2c [symbol] nother example of the inventive process, whi [symbol] carries part of the rich absorbent through heat exchanger H3, where it is heated by the rich absorbent stream, and then into line L3.

Line L1 carries the rich feed stream from heat exchanger H5 through heat exchanger H3 and then into column C1. Optionally, a supplemental cooler may further cool the rich feed stream after heat exchanger H3 before it enters column C1. Unlike FIG. 1, there is no heat exchanger H4, and line L1 does not go through heat exchanger H4.

### FIG. 3:

FIG. 3 illustrates another example of the inventive process, which includes alternate heat integration. FIG. 3 proceeds like FIG. 1 except as follows. Line L2 splits into three separate lines L2a, L2b and L2c, each carrying rich absorbent. Lines L2a and L2b proceed as in FIG. 1. Line L2c carries part of the rich absorbent through heat exchanger H3, where it is heated by the high pressure carbon dioxide stream, and then into line L3.

Line L7 receives the high pressure carbon dioxide stream from flash drum S1. It carries the high pressure carbon dioxide stream through heat exchanger H3, where it heats the rich absorbent stream, and then to where the high pressure carbon dioxide is recovered.

### FIG. 4:

FIG. 4 illustrates another example of the inventive process, which includes alternate heat integration incorporating refinements from FIGS. 1, 2 and 3. FIG. 4 proceeds like FIG. 1 except as follows. Line L2 splits into three separate lines L2a, L2b and L2c, each carrying rich absorbent. Lines L2a and L2b proceed as in FIG. 1. Line L2c carries part of the rich absorbent through heat exchanger H3 and then heat exchanger H6 and then into line L3.

Line L1 carries the rich feed stream through three different heat exchangers and then into column C1. First, the rich feed stream goes through heat exchanger H5, as in FIG. 1. Second, the rich feed stream goes through heat exchanger H4, as in FIG. 1. Third, the rich feed stream goes through heat exchanger H6 where it heats the rich absorbent stream. Optionally, a supplemental cooler (not shown) may further cool the rich feed stream after heat exchanger H6 before it enters column C1.

Line L7 receives the high pressure carbon dioxide stream from flash drum S1. It carries the high pressure carbon dioxide stream through heat exchanger H3, where it heats the rich absorbent stream, and then to where the high pressure carbon dioxide is recovered.

### EXAMPLES

The following examples illustrate specific embodiments of the invention, but do not limit the broadest scope of the invention.

FIG. 1 illustrates a carbon dioxide recovery system for Inventive Example 1. FIG. 2 illustrates a carbon dioxide recovery system for Inventive Example 2. FIG. 3 illustrates a carbon dioxide recovery system for [symbol] rbon dioxide recovery system for Inventive Example 4. [symbol] Inventive Example 3. FIG. 4 illustrates a ca

[symbol]

As a Comparative Example (CE1), Example 1 from Iijima et al., Australian Patent 728167 2001) is modeled.

Each example recovers carbon dioxide from a rich feed stream that is the output of a water gas shift process. The rich feed stream is described in Table 1.

TABLE 1

| Stream Property | Units | |
|---|---|---|
| Pressure | bar(a) | 26.0 |
| Temperature before H5 | ° C. | 154 |
| Temperature at C1 | ° C. | 40.0 |
| Flow rate | m³/hr | 19526 |
| Composition | | |
| Water | mol-% | 0.3 |
| Hydrogen | mol-% | 73.9 |
| Carbon Dioxide | mol-% | 24.7 |
| Carbon Monoxide | mol-% | 0.7 |
| Methane | mol-% | 0.4 |

Each example uses an absorbent that contains 25 weight percent water and 75 weight percent of UCARSOL™ Hybrid 920 hybrid absorbent blend, based solely on the weight of water and hybrid absorbent blend, excluding the weight of any dissolved carbon dioxide. The lean absorbent entering the absorption step is at a temperature of 30 °C and a pressure of 26.1 bar. Flow rates are shown in Table 3.

Details of each recovery systems in IE1-IE 4 are listed in Table 2. As a Comparative Example (CE1), Example 1 from Iijima et al., Australian Patent 728167 (2001) is modeled.

TABLE 2
Equipment specifications and operating parameters for the examples

| Absorber | | |
|---|---|---|
| Operating Pressure | bar(a) | 21 |
| Diameter | m | 2.9/4.9 (swaged) |
| Absorbent Feed Location | - | Top of packing |
| Gas Feed Location | - | Bottom of packing |
| Packing height | m | 4 sections each 6 m |
| Packing type | - | Raschig Super Rings #2 |
| Intercooler Draw Depth | m | 16.7 |
| Intercooler Draw Fraction | - | 0.99 |
| Intercooler Return Depth | m | 16.7 |
| Intercooler Temperature | ° C. | 30.0 |
| Specification | | |
| Pumparound flow | m³/hr | 1100 |
| Pumparound return depth | m | 21 |
| Heat Exchangers | | |
| Cold-side Approach Temperature | ° C. | 5 |
| Regenerator | | |
| Operating Pressure | bar(a) | Varies (see Table 4) |
| Diameter | m | 4 |
| Absorbent Feed Location | - | Top of packing |
| Packing height | m | 4 |
| Packing type | - | Raschig Super Rings #2 |
| Reboiler Duty | - | Varies (see Table 4) |
| Separators (IE1-IE4 only) | | |
| Separator type | - | Adiabatic Flash |
| Operating Pressure | - | Varies (see Table 4) |

Table 3 shows the operation of each recovery system at steady state. In Table 3, Separator 1 is the high pressure regeneration, Separator 2 is the medium pressure regeneration, and Regenerator is the low pressure regeneration. Each system recovers more than 99 percent of available carbon dioxide. Each system recovers a high pressure, medium pressure and low pressure carbon dioxide stream. Absorbent temperature, absorbent loading and power consumption is recorded in each system. The inventive examples achieve results similar to the comparative example, using inexpensive flash drums rather than an expensive high pressure tower. The inventive examples use less power than the comparative example. The inventive examples expose the absorbent to less heat and lower loading levels than the comparative example; heat and high loadings are known to degrade absorbent.

TABLE 3

| | | | | IE3 | IE4 | CE1 |
|---|---|---|---|---|---|---|
| | | IE1 | IE2 | HPR Two- | HPR Two- | Australian |
| | | HPR Two- | HPR Two- | stage w/ | stage w/ | Patent |
| Parameter/ | | stage w/ | stage w/ | 2-Series SGHX | 3-Series SGHX | 728167 |
| Result | Units | 2-Series SGHX | 3-Series SGHX | and OVHD HX | and OVHD HX | Example 1 |
| Absorbent | m³/hr | 2295 | 2295 | 2295 | 2295 | 1941 |
| Circulation | | | | | | |
| Rate | | | | | | |
| Separator 1 | bar(a) | 15 | 15 | 15 | 15 | 10.7 |
| Pressure | | | | | | |
| Separator 2 | bar(a) | 7 | 7 | 7 | 7 | N/A |
| Pressure | | | | | | |
| Separator 1 | °C | | | | | |
| Temperature | | | | | | |
| Separator 2 | °C | | | | | N/A |
| Temperature | | | | | | |
| Regenerator | bar(a) | 3 | 3 | 3 | 3 | 1.7 |
| Pressure | | | | | | |
| Separator 1 | kmol/hr | 2890 | 2869 | 2844 | 3273.4 | 2229.8 |
| CO2 Flow | | | | | | |
| Separator 2 | kmol/hr | 1384 | 1397 | 1420 | 1004 | N/A |
| CO2 Flow | | | | | | |
| Regenerator | Bar(a) | | | | | |
| Pressure | | | | | | |
| Regenerator | °C | | | | | |
| Temperature | | | | | | |
| Regenerator | kmol/hr | 492 | 494 | 497 | 489.5 | 235 |
| CO2 Flow | | | | | | |
| Steam Duty | MW | 40.6 | 6.89 | 33.26 | 6.89 | 54.2 |
| Treated Gas | kmol/hr | 4.4735 | 5.26 | 7 | 3.4149 | 4.47 |
| CO2 | | | | | | |
| CO2 | % | 99.91% | 99.89% | 99.85% | 99.93% | 99.82% |
| Removal | | | | | | |
| Compression | MW | 9.0 | 8.97 | 9.00 | 8.69 | 4.9 |
| Power | | | | | | |
| Power Lost | MW | 10.1 | 1.7 | 8.2 | 1.7 | 13.4 |
| Pump Power | MW | 1.7 | 1.7 | 1.7 | 1.7 | 1.8 |
| Total Power | MW | 20.7 | 12.3 | 18.9 | 12.0 | 20.2 |

1. A process to recover carbon dioxide from a gaseous feed stream having at least 1 bar of partial pressure of carbon dioxide, called the “rich feed stream,” using an aqueous liquid absorbent that absorbs carbon dioxide, called the “absorbent”, which process comprising the following steps:
(a) an absorption step that takes place wherein rich feed stream is contacted with the aqueous absorbent in an absorption column under an absorption temperature of no more than 120 °C and an absorption pressure of at least 8 bar for a period of time such that carbon dioxide is absorbed from the rich feed stream into the aqueous absorbent to produce a gaseous feed stream than contains reduced carbon dioxide, called the “lean feed stream”, and an absorbent containing increased levels of carbon dioxide, called the “rich absorbent”; and
(b) a regeneration step wherein the rich absorbent from the absorption step is subjected to a regeneration pressure lower than the absorption pressure and a regeneration temperature higher than the absorption temperature for a period of time such that carbon dioxide is desorbed from the absorbent and recovered, to form a lean absorbent that contains less carbon dioxide than the rich absorbent and is returned to the absorption step; and
(c) a transition step wherein (i) the rich absorbent passing from the absorption step to the regeneration step is heated and depressurized to prepare for the regeneration step and (ii) the lean absorbent passing from the regeneration step to the absorption step is cooled and pressurized to prepare for the absorption step, which transition step includes transferring heat from the lean absorbent to the rich absorbent in one or more heat exchangers,
characterized in that:
(1) The regeneration step comprises at least:
i. a high pressure regeneration stage, in which carbon dioxide is partially desorbed from the rich absorbent at a temperature from 80 °C to 140 °C and a pressure of from 3 to 40 bar in a separator which is either a flash drum or an in-line separator, to provide a (A) high pressure carbon dioxide stream with a pressure of at least 8 bar and (B) a semi-lean absorbent that contains no more than 90 percent of the carbon dioxide loading of the rich absorbent, and
ii. a low pressure regeneration stage, in which further carbon dioxide is desorbed from a portion of the semi-lean absorbent in a regeneration column at a temperature higher than the temperature of the high pressure regeneration and a pressure lower than the pressure of the high pressure regeneration, to provide (A) a low pressure carbon dioxide stream with a pressure lower than the high pressure carbon dioxide stream and (B) the lean absorbent stream, which contains no more than 50 percent of the carbon dioxide loading of the rich absorbent; and
(2) the semi-lean absorbent from the high pressure regeneration stage is split with part of the semi-lean absorbent sent to the low pressure regeneration and part of the semi-lean absorbent returned through the transition step to the absorption step; and
(3) in the absorption step: (i) the rich feed stream is introduced into the absorption column in a lower portion of the absorption column and moves toward the top of the column, (ii) the lean absorbent is introduced into the absorption column in an upper portion of the column and moves toward the bottom of the column counter-current to the rich feed stream, (iii) the semi-lean absorbent is introduced into the absorption column at a point between the rich feed stream and the lean absorbent stream and moves toward the bottom of the column counter-current to the rich feed stream, (iv) the lean feed stream is recovered from the upper portion of the column, and (v) the rich absorbent is recovered from the lower portion of the column.

2. The process of claim 1 wherein, in the transition stage, the stream of rich absorbent is split into at least a first and second stream, the first stream of rich absorbent passes through a first heat exchanger and is heated by the lean absorbent, the second stream of rich absorbent passes through a second heat exchanger and is heated by the semi-lean absorbent, and the separated streams of rich absorbent are recombined.

3. The process of claim 1 wherein the regeneration step further comprises: a medium pressure regeneration stage in which carbon dioxide is partially desorbed from the semi-lean absorbent, after it leaves the high pressure regeneration stage and before it enters the low pressure regeneration stage, in a separator which is either a flash drum or an in-line separator at a temperature from 80 °C to 140 °C and a pressure of from 3 to 15 bar, to provide a (A) medium pressure carbon dioxide stream with a pressure from 3 to 15 bar and (B) a semi-lean absorbent having reduced carbon dioxide.

4. The process of claim 3 wherein the rich feed stream enters the process with a temperature of at least 150 °C, and heat is recovered from the rich feed stream in at least two of the following four points in the process:
(a) in a reboiler that heats contents of the low pressure regeneration column;
(b) in a heat exchanger that heats rich absorbent before the high pressure regeneration;
(c) in a heat exchanger that heats semi-lean absorbent before the medium pressure regeneration; and
(d) in a heat exchanger that heats semi-lean absorbent before the low pressure regeneration.

5. The process of claim 4 wherein heat is recovered from the rich feed stream in the reboiler of (a) and in at least one of the heat exchangers of (b)-(d).

6. The process of claim 4 wherein heat is recovered from the rich feed stream in the reboiler of (a), in the heat exchanger of (b), and in the heat exchanger of (c).

7. The process of claim 4 wherein is heat is further recovered from the high pressure carbon dioxide stream in a heat exchanger that heats rich absorbent before the high pressure regeneration.

8. The process of claim 4 wherein the separators in the high pressure regeneration and the medium pressure regeneration are each flash drums.

9. The process of claim 4 wherein the separators in the high pressure regeneration and the medium pressure regeneration are each inline separators.

10. The process of claim 4 wherein the high pressure regeneration takes place at a pressure from 8 to 20 bar, the medium pressure regeneration takes place at a pressure from 5 to 10 bar and the low pressure regeneration takes place at a pressure from 0.5 to 5 bar.

11. The process of claim 4 wherein the high pressure regeneration takes place at a pressure from 12 to 15 bar, the medium pressure regeneration takes place at a pressure from 6 to 9 bar and the low pressure regeneration takes place at a pressure from 1 to 3 bar.

12. The process of claim 4 wherein the semi-lean absorbent is introduced into the absorption column from 30 percent to 70 percent of the tower height below the lean absorbent stream, based on the distance between the lean absorbent and the rich feed stream introduction points.

13. The process of claim 11 wherein 70 to 95 percent of carbon dioxide recovered in the process are recovered in the high pressure carbon dioxide stream or the medium pressure carbon dioxide stream.

14. The process of claim 1 wherein the absorbent is a hybrid aqueous absorbent that contains water, a physical organic absorbent for carbon dioxide, and a chemical organic absorbent for carbon dioxide.

15. The process of claim 14 wherein the chemical absorbent comprises an organic amine and the physical solvent comprises a low molecular weight polyalkylene glycols and its mono-ether, a cyclic sulfone, thiodiglycol or glycerin.
